(19) United States
(12) Patent Application Publication
(10) Pub. No.: US 2017/0143009 A1
(43) Pub. Date: May 25, 2017

(54) ANIMAL FEED AND AQUAFEED

(71) Applicant: DUPONT NUTRITION BIOSCIENCES APS, Copenhagen K (DK)

(72) Inventors: Ajay Awati, Swindon (GB); Stephane Frouel, Paris (FR); Tracey Sainsbury, Highworth (GB)

(73) Assignee: DUPONT NUTRITION BIOSCIENCES APS, Copenhagen K (DK)

(21) Appl. No.: 15/320,281

(22) PCT Filed: Jun. 24, 2015
(86) PCT No.: PCT/EP2015/064291

§ 371 Date: Dec. 19, 2016

(30) Foreign Application Priority Data
Jun. 24, 2014 (GB) 1411194.2

(51) Int. Cl. A23K 50/80; A23K 40/30; A23K 40/10; A23K 20/10; A23K 20/158

(52) U.S. Cl. CPC A23K 50/80; A23K 20/10; A23K 20/158; A23K 40/10; A23K 40/30

(57) ABSTRACT

The present invention relates to a feed comprising betaine or a feed acceptable salt or hydrate thereof and a feed meal in a reduced amount, and the use of betaine or a feed acceptable salt or hydrate thereof as a feed meal replacement in an animal feed or aquafeed.

### FIELD OF THE INVENTION

The present invention relates to a feed and the use of betaine as a component thereof.

### BACKGROUND OF THE INVENTION

Supplementation of fish meal in the diets of animals and aquaculture is known to provide a number of benefits. In particular, fish meal increases feed efficiency, growth, aids palatability, and enhances nutrient uptake, digestion and absorption.

Fish meal is widely used as the main source of dietary protein for most commercially farmed fish, in part because fish meal provides a balanced amount of the essential amino acids.

However, fish meal is the single most expensive major ingredient in aquaculture feeds. Increased demand, driven by growth in the aquaculture industry and terrestrial farm animal industry has increased fish meal prices. Presently, the industrial sector has a definitive goal to reduce its dependence on the unsustainable supply of this expensive raw material. Furthermore, from an environmental point of view, the phosphorous content of the fish meal is also a major problem.

There have been many attempts to replace fish meal with less expensive protein sources in animal feeds and/or aquafeeds. However, attempts to rely on other proteins (such as those from cereal grains or plant proteins) have been found to have low nutritional value due to a lack of properly balanced essential amino acids.

There is a need in the art for the provision of animal feeds and/or aquafeeds with a reduced amount of fish meal, which have the required nutritional value.

### SUMMARY OF INVENTION

In a first aspect, the present invention relates to a feed for use as an animal feed or aquafeed; wherein said feed comprises feed meal and betaine or a feed acceptable salt or hydrate thereof; wherein said feed provides at least a similar (e.g. similar or improved) nutritional value, when fed to an animal or an aquaspecies, as compared with the nutritional value provided by a comparable feed that contains a higher level of feed meal and does not contain betaine or a feed acceptable salt or hydrate thereof.

In a second aspect, the present invention relates to a feed for use as an animal feed or aquafeed; wherein said feed comprises feed meal and betaine or a feed acceptable salt or hydrate thereof; wherein said feed provides at least a similar (e.g. similar or improved) utilization, when fed to an animal or an aquaspecies, as compared with the utilization provided by a comparable feed that contains a higher level of feed meal and does not contain betaine or a feed acceptable salt or hydrate thereof.

In a third aspect, the present invention relates to a feed for use as an animal feed or aquafeed, wherein said feed comprises betaine or a feed acceptable salt or hydrate thereof and a feed meal in a reduced amount.

In a fourth aspect, the present invention relates to the use of betaine or a feed acceptable salt, or hydrate thereof as a feed meal replacement in an animal feed or an aquafeed.

In a fifth aspect, the present invention relates to the use of betaine or a feed acceptable salt or hydrate thereof for maintaining or improving the nutritional value of a feed comprising feed meal in a reduced amount.

In a sixth aspect, the present invention relates to the use of betaine or a feed acceptable salt or hydrate thereof for maintaining or improving the utilization of a feed comprising feed meal in a reduced amount.

In a seventh aspect, the present invention relates to a method of providing nourishment to an animal or an aquaspecies comprising feeding said animal or aquaspecies with a feed according to any one of the first to the third aspects.

### DETAILED DESCRIPTION OF THE INVENTION

In one aspect, the present invention relates to a feed for use as an animal feed or aquafeed; wherein said feed comprises feed meal and betaine or a feed acceptable salt or hydrate thereof; wherein said feed provides at least a similar (e.g. similar or improved) nutritional value, when fed to an animal or an aquaspecies, as compared with the nutritional value provided by a comparable feed that contains a higher level of feed meal and does not contain betaine or a feed acceptable salt or hydrate thereof.

In one aspect, the present invention relates to a feed for use as an animal feed or aquafeed; wherein said feed comprises feed meal and betaine or a feed acceptable salt or hydrate thereof; wherein said feed provides at least a similar (e.g. similar or improved) utilization, when fed to an animal or an aquaspecies, as compared with the utilization provided by a comparable feed that contains a higher level of feed meal and does not contain betaine or a feed acceptable salt or hydrate thereof.

In one aspect, the present invention relates to a feed for use as an animal feed or aquafeed, wherein said feed comprises betaine or a feed acceptable salt or hydrate thereof and a feed meal in a reduced amount.

As used herein, the term “feed” refers to a composition consumed in order to provide nourishment. In one embodiment the feed is an animal feed or an aquafeed which are compositions consumed by an animal or an aquaspecies respectively in order to provide nourishment. Preferably, the feed is an aquafeed.

As used herein, the term “feed meal” refers to a protein-rich feed component derived from cereals, plants, animals or fish. Feed meals may be provided in comminuted and/or dried form.

Particularly preferred feed meals may be selected from fish meal, chicken meal, soybean meal, hydrolysed feather meal, blood meal, meat and bone meal. Preferably, the feed meal is fish meal.

As used herein, “fish meal” refers to meal produced by the boiling of landed fish and other aquatic animal species (either caught or produced), separating out water and oil (e.g. by use of a press), and then drying. Normally fish meal is dried to a moisture content of less than or equal to about 10%, and then the fish meal is distributed at room temperature. Many fish species may be used as the raw material of fish meal, such as horse mackerel, true sardine, various other sardines, mackerel, herring, capelin smelt, sand eel, various types of codfish, and Antarctic krill.

As used herein the term “betaine” refers to trimethylglycine. The compound is also called trimethylammonioacetate, 1-carboxy-N,N,N-trimethylmethaneaminium, inner salt and glycine betaine. It is a naturally occurring quaternary ammonium type compound having the formula

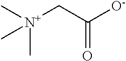

Betaine has a bipolar structure comprising a hydrophilic moiety (COO—) and a hydrophobic moiety (N+) capable of neutralizing both acid and alkaline solutions. In its pure form, betaine is a white crystalline compound that is readily soluble in water and lower alcohols. In the present invention betaine can be used, for example, as anhydrous form, or as a monohydrate or feed acceptable salt.

Betaine is commercially available from Finnfeeds Finland Oy as an anhydrous form and also as a monohydrate.

In one embodiment, betaine is present as the free zwitterion.

In one embodiment, betaine is present as anhydrous betaine.

In one embodiment, betaine is present as a monohydrate.

In one embodiment, betaine is present in the feed in amount of at least about 0.1% of betaine (net) (w/w), preferably at least about 0.25% of betaine (net) (w/w).

As used herein in relation to the proportion of betaine present, the term “net” refers to the proportion of betaine on an uncoated basis.

In another embodiment, betaine is present in the feed in amount of about 0.1% (net) (w/w) up to and inclusive of about 1% (net) (w/w), preferably in amount of about 0.1% (net) (w/w) up to and inclusive of about 0.7% (net) (w/w), preferably in amount of about 0.1% (net) (w/w) up to and inclusive of about 0.5% (net) (w/w), preferably in amount of about 0.1% (net) (w/w) up to and inclusive of about 0.4% (net) (w/w), preferably in amount of about 0.1% (net) (w/w) up to and inclusive of about 0.3% (net) (w/w), preferably in amount of about 0.25% (w/w).

In another embodiment, betaine is present in the feed in amount of about 0.25% (net) (w/w) up to and inclusive of about 1% (net) (w/w), preferably in amount of about 0.25% (net) (w/w) up to and inclusive of about 0.7% (net) (w/w), preferably in amount of about 0.25% (net) (w/w) up to and inclusive of about 0.5% (net) (w/w), preferably in amount of about 0.25% (net) (w/w) up to and inclusive of about 0.4% (net) (w/w), preferably in amount of about 0.25% (net) (w/w) up to and inclusive of about 0.3% (net) (w/w).

As used herein, the term “feed acceptable salt” refers to any non-toxic salt that, upon administration to an animal or aquaspecies, is capable of providing, either directly or indirectly, betaine. Acids commonly employed to form acceptable salts include inorganic acids such as hydrogen bisulfide, hydrochloric, hydrobromic, hydroiodic, sulfuric and phosphoric acid, as well as organic acids such as para-toluenesulfonic, salicylic, tartaric, bitartaric, ascorbic, maleic, besylic, fumaric, gluconic, glucuronic, formic, glutamic, methanesulfonic, ethanesulfonic, benzenesulfonic, lactic, oxalic, para-bromophenylsulfonic, carbonic, succinic, citric, benzoic and acetic acid, and related inorganic and organic acids. Such animal feed acceptable salts thus include sulfate, pyrosulfate, bisulfate, sulfite, bisulfite, phosphate, monohydrogenphosphate, dihydrogenphosphate, metaphosphate, pyrophosphate, chloride, bromide, iodide, acetate, propionate, decanoate, caprylate, acrylate, formate, isobutyrate, caprate, heptanoate, propiolate, oxalate, malonate, succinate, suberate, sebacate, fumarate, maleate, butyne-1,4-dioate, hexyne-1,6-dioate, benzoate, chlorobenzoate, methylbenzoate, dinitrobenzoate, hydroxybenzoate, methoxybenzoate, phthalate, terephathalate, sulfonate, xylenesulfonate, phenylacetate, phenylpropionate, phenylbutyrate, citrate, lactate, [beta]-hydroxybutyrate, glycolate, maleate, tartrate, methanesulfonate, propanesulfonate, naphthalene-1-sulfonate, naphthalene-2-sulfonate, mandelate and the like salts. Preferred feed acceptable acid addition salts include those formed with mineral acids such as hydrochloric acid and hydrobromic acid, and those formed with organic acids such as maleic acid.

Suitable cations for forming feed acceptable salts include ammonium, sodium, potassium, calcium, magnesium and aluminium cations, among others.

Preferably, the feed acceptable salt is an acid addition salt. More preferably, a hydrochloride salt.

As used herein, the term “nutritional value” may refer any one or more of the following:
i. the ability of the feed to sustain the life of an animal or an aquaspecies once the feed is consumed by an animal or an aquaspecies. In one embodiment, this may be measured as survival rate (%). The skilled person would be aware of how to determine survival rate (%) for any given animal feed or aquafeed. For instance, in any given feeding study, survival rate (%) can be calculated according to the following equation: survival rate (%)=100×(number of living subjects at the end of the study/number of living subjects at the start of the study). The skilled person would be aware of other methods of determining an improvement in the ability of an animal feed or aquafeed to sustain the life of an animal or aquaspecies after consumption of the animal feed or aquafeed.
ii. the ability of the feed to promote weight gain in an animal or aquaspecies. In one embodiment, this may be measured as weight gain. The skilled person would be aware of a number of ways to determine a weight gain. For instance, % weight gain for an animal feed or aquafeed in any given study may be determined as follows: weight gain (%)=([mean final bodyweight of living subjects at the end of the study−mean initial body weight of living subjects at the start of the study]/mean initial body weight of living subjects at the start of the study)×100. Alternatively, weight gain may be expressed as a mean weight gain per subject. This can be calculated for any given study by measuring the total biomass of living subjects at the end of the study and dividing this figure by the number of living subjects at the end of the study. The skilled person would be aware of other methods of determining an improvement in the ability of an animal feed or aquafeed to promote weight gain in an animal or aquaspecies after consumption of the animal feed or aquafeed.

In one embodiment, nutritional value may be determined based upon survival rate (%) of an animal or an aquaspecies or a group thereof.

Accordingly, in one embodiment the feed comprising betaine has a survival rate (%) which is substantially the same as the survival rate (%) of the feed that does not contain betaine.

In one embodiment, the survival rate of the feed comprising betaine and the feed which does not contain betaine are both at least about 80%, preferably at least about 90%, more preferably at least about 95%.

In one embodiment, nutritional value may be determined based upon weight gain (%).

Accordingly, in one embodiment the feed comprising betaine has a weight gain (%) which is substantially the same as the weight gain (%) of the feed that does not contain betaine.

In one embodiment at least a similar (e.g. similar or improved) nutritional value of the feed comprising betaine and the feed that does not contain betaine may be determined wherein both give rise to a 50 to 1000% increase in weight gain, preferably a 50 to 500% increase in weight gain, more preferably a 100 to 500% increase in weight gain, 200% to 500% increase in weight gain, 300 to 500% increase in weight gain, preferably a 400 to 500% increase in weight gain.

In one embodiment, at least a similar (e.g. similar or improved) nutritional value may be determined by wherein both feeds provide a 100% or greater increase in weight gain (%). More preferably, a 200% or greater increase in weight gain (%). More preferably, a 300% or greater increase in weight gain (%). More preferably, a 400% or greater increase in weight gain (%).

In one embodiment, the feed comprising betaine has a weight gain (%) which is improved compared to the weight gain (%) of the feed that does not contain betaine.

In one embodiment an improvement in nutritional value may be determined by at least about a 1% increase in weight gain (%) of the feed comprising betaine compared to the feed which does not comprise betaine; preferably, at least about a 2% increase in weight gain (%) of the feed comprising betaine compared to the feed which does not comprise betaine; more preferably, at least about a 3% increase in weight gain (%) of the feed comprising betaine compared to the feed which does not comprise betaine; more preferably at least about a 4% increase in weight gain (%) of the feed comprising betaine compared to the feed which does not comprise betaine; more preferably, at least about a 5% increase in weight gain (%) of the feed comprising betaine compared to the feed which does not comprise betaine; more preferably, at least about a 6% increase in weight gain (%) of the feed comprising betaine compared to the feed which does not comprise betaine; more preferably, at least about a 7% increase in weight gain (%) of the feed comprising betaine compared to the feed which does not comprise betaine; more preferably, at least about an 8% increase in weight gain (%) of the feed comprising betaine compared to the feed which does not comprise betaine; more preferably, at least about a 9% increase in weight gain (%) of the feed comprising betaine compared to the feed which does not comprise betaine; more preferably, at least about a 10% increase in weight gain (%) of the feed comprising betaine compared to the feed which does not comprise betaine.

As used herein, the term “utilization” may refer to one or more of the following:
i. Feed intake (g) by an animal or aqua species;
ii. Feed conversion ratio (FCR). In one embodiment, the feed conversion ratio is a measure of the amount of feed required for a certain amount of growth (increase in biomass). In one embodiment the FCR for an animal feed or aquafeed in any given study may be determined as follows:

FCR=total dry feed intake (g)/(biomass of living subjects at the end of the study(g)−biomass of living subjects at the start of the study+biomass of subjects which died during the study).

In one embodiment, utilization may be determined based feed intake.

Accordingly, in one embodiment the feed comprising betaine has a feed intake (g) which is substantially the same as the feed intake (g) of the feed that does not contain betaine.

In one embodiment, the feed comprising betaine has a feed intake (g) which is improved compared to the feed intake (g) of the feed that does not contain betaine.

In one embodiment, an improvement in utilization may be determined by at least about a 1% improvement in feed intake (g) of the feed comprising betaine compared to the feed which does not comprise betaine; preferably, at least about a 2% improvement in feed intake (g) of the feed comprising betaine compared to the feed which does not comprise betaine; more preferably, at least about a 3% improvement in feed intake (g) of the feed comprising betaine compared to the feed which does not comprise betaine; more preferably at least about a 4% improvement in feed intake (g) of the feed comprising betaine compared to the feed which does not comprise betaine; more preferably, at least about a 5% improvement in feed intake (g) of the feed comprising betaine compared to the feed which does not comprise betaine.

In one embodiment, utilization may be determined based upon FCR.

Accordingly, in one embodiment the feed comprising betaine has an FCR which is substantially the same as the FCR of the feed that does not contain betaine.

In one embodiment at least a similar (e.g. similar or improved) utilization of the feed comprising betaine and the feed that does not contain betaine may be determined wherein both give rise to an FCR of between 1 and 3; more preferably an FCR of between 1 and 2.5; more preferably an FCR of between 1.5 and 2.5; more preferably an FCR of between 1.5 and 2.0.

In one embodiment, the feed comprising betaine has an FCR which is improved compared to the FCR of the feed that does not contain betaine.

In one embodiment an improvement in utilization may be determined by at least about a 1% improvement in FCR of the feed comprising betaine compared to the feed which does not comprise betaine; preferably, at least about a 2% improvement in FCR of the feed comprising betaine compared to the feed which does not comprise betaine; more preferably, at least about a 3% improvement in FCR of the feed comprising betaine compared to the feed which does not comprise betaine; more preferably at least about a 4% improvement in FCR of the feed comprising betaine compared to the feed which does not comprise betaine; more preferably, at least about a 5% improvement in FCR of the feed comprising betaine compared to the feed which does not comprise betaine.

In one embodiment, the feed which does not contain betaine comprises a higher level of feed meal, wherein a higher level refers to between about 50% and about 400% more feed meal than the feed which comprises betaine. In another embodiment, the feed which does not contain betaine comprises a higher level of feed meal, wherein a higher level refers to between about 100% and about 400% more feed meal than the feed which comprises betaine. In another embodiment, the feed which does not contain betaine comprises a higher level of feed meal, wherein a higher level refers to between about 100 and about 300% more feed meal than the feed which comprises betaine. In another embodiment, the feed which does not contain betaine comprises a higher level of feed meal, wherein a higher level refers to between about 150 and about 300% more feed meal than the feed which comprises betaine. In another embodiment, the feed which does not contain betaine comprises a higher level of feed meal, wherein a higher level refers to between about 200 and about 300% more feed meal than the feed which comprises betaine.

In one embodiment, both feeds comprise fish meal and the feed which does not contain betaine comprises a higher level of fish meal, wherein a higher level refers to between about 50% and about 400% more fish meal than the feed which comprises betaine. In another embodiment, the both feeds comprise fish meal and the feed which does not contain betaine comprises a higher level of fish meal, wherein a higher level refers to between about 100% and about 400% more fish meal than the feed which comprises betaine. In another embodiment, the both feeds comprise fish meal and the feed which does not contain betaine comprises a higher level of fish meal, wherein a higher level refers to between about 100 and about 300% more fish meal than the feed which comprises betaine. In another embodiment, the both feeds comprise fish meal and the feed which does not contain betaine comprises a higher level of fish meal, wherein a higher level refers to between about 150 and about 300% more fish meal than the feed which comprises betaine. In another embodiment, the both feeds comprise fish meal and the feed which does not contain betaine comprises a higher level of fish meal, wherein a higher level refers to between about 200 and about 300% more fish meal than the feed which comprises betaine.

In one embodiment, the present invention relates to a shrimp feed comprising betaine (as defined above) and a reduced amount of feed meal (as defined above) having an FCR (as defined above).

In one embodiment, the term “reduced amount” refers to a lower amount than the amount conventionally used in feeds, particularly animal feeds or aquafeeds which do not contain betaine or a feed acceptable salt or hydrate thereof. In another embodiment, reduced amount refers to between about 10% and about 90% less feed meal. In another embodiment, between about 10 and about 80% less feed meal. In another embodiment, between about 10 and about 70% less feed meal. In another embodiment, between about 10 and about 60% less feed meal. In another embodiment, between about 10 and about 50% less feed meal. In another embodiment, between about 30 and about 80% less feed meal. In another embodiment, between about 30 and about 70% less feed meal. In another embodiment, between about 30 and about 60% less feed meal. In another embodiment, between about 30 and about 50% less feed meal.

In one embodiment, the feed meal is fish meal and a reduced amount of fish meal is present in the feed of the present invention, preferably as defined above.

As used herein, the term “fish meal in a reduced amount” refers to fish meal in a lower amount than that conventionally used in feeds, particularly animal or aquafeeds.

In one embodiment, a reduced amount of feed meal is about 10% (w/w) or less of the feed, preferably about 9% (w/w) or less, more preferably about 8% (w/w) or less, more preferably about 7% (w/w) or less, more preferably about 6% (w/w) or less, more preferably about 5% (w/w) or less, more preferably about 4% (w/w) or less, more preferably to between about 0.1 to about 5% (w/w), more preferably to between about 0.5 to about 5% (w/w), more preferably to between about 1 to about 5% (w/w), more preferably to between about 2 to about 5% (w/w), more preferably to between about 1 to about 4% (w/w), more preferably about 4% (w/w).

In one embodiment, a reduced amount of fish meal is about 10% (w/w) or less of the feed, preferably about 9% (w/w) or less, more preferably about 8% (w/w) or less, more preferably about 7% (w/w) or less, more preferably about 6% (w/w) or less, more preferably about 5% (w/w) or less, more preferably about 4% (w/w) or less, more preferably to between about 0.1 to about 5% (w/w), more preferably to between about 0.5 to about 5% (w/w), more preferably to between about 1 to about 5% (w/w), more preferably to between about 2 to about 5% (w/w), more preferably to between about 1 to about 4% (w/w), more preferably about 4% (w/w).

Coating Substance

In one embodiment, the betaine may be coated with a coating substance. In this advantageous embodiment, the coating substance reduces leaching of the betaine from the animal feed or aquafeed when it is contacted with aqueous media.

The aqueous media referred to above may be selected from stomach acids, rumen fluid, sodium chloride solution, seawater, river water, pond water and water suitable for drinking.

In one embodiment, the coating substance comprises a lipid, an emulsifier or a polymer. In another embodiment, the coating substance comprises a lipid or a polymer. In another embodiment, the coating substance comprises a lipid.

In one embodiment, the coating substance consists essentially of a lipid, an emulsifier or a polymer. In another embodiment, the coating substance consists essentially of a lipid or a polymer. In another embodiment, the coating substance consists essentially of a lipid.

In one embodiment, the coating substance consists of a lipid, an emulsifier or a polymer. In another embodiment, the coating substance consists of a lipid or a polymer. In another embodiment, the coating substance consists of a lipid.

In one embodiment, the emulsifier is selected from fatty acid monoglycerides, diglycerides, polyglycerol esters and sorbitan esters of fatty acids.

In one embodiment, the lipid is selected from animal oils or fats, vegetable oils or fats, triglycerides, free fatty acids, animal waxes, (such as beeswax, lanolin, shell wax or Chinese insect wax), vegetable waxes (such as carnauba, candelilla, bayberry or sugarcane), mineral waxes, synthetic waxes, natural and synthetic resins and mixtures thereof.

In another embodiment, the lipid is selected from animal oils or fats, vegetable oils or fats, triglycerides, vegetable waxes (such as carnauba, candelilla, bayberry or sugarcane), mineral waxes, synthetic waxes, natural and synthetic resins and mixtures thereof.

In another embodiment, the lipid is selected from hardened vegetable oils or fats, triglycerides, and mixtures thereof.

Preferably the lipid is a fat, preferably a vegetable-derived fat.

Preferably the fat is solid at room temperature. More preferably the fat has a melting point of about 40° C. or more. More preferably the fat has a melting point of about 50° C. or more. More preferably the fat has a melting point of about 60° C. or more.

In one embodiment, the fat has a melting point of about 40° C. to about 80° C., preferably the fat has a melting point of about 50° C. to about 80° C., preferably the fat has a melting point of about 55° C. to about 75° C., preferably the fat has a melting point of about 55° C. to about 70° C.

Preferably the fat is a hardened fat, more preferably a fully hardened fat.

In another embodiment, the coating substance comprises a lipid selected from a hardened fat, more preferably a fully hardened fat.

The term “hardened fat” or “hydrogenated fat” is fat that has been exposed to a hydrogenation process (Ullmann's Encyclopaedia of Industrial Chemistry, Sixth Edition, Fats and Fatty Oils, 4.3 and 8). Typically, the fat is subjected to catalytic hydrogenation in the presence of a transition metal catalyst, for example, a nickel, palladium or platinum catalyst.

Fully hardened fat is defined as a fat having an Iodine Value (IV) of less than 5, where the iodine value is measured by the conventional IUPAC technique (International Union of Pure and Applied Chemistry (IUPAC), Standard Method for the Analysis of Oils, Fats and Derivatives, Method 2.205).

Preferably, the fats are free fatty acids (such as stearic acid, palmitic acid and oleic acid) or derivatives of fatty acids and glycerol. More preferably, the fats are comprised of triglycerides.

The term “triglyceride” preferably means a triester of glycerol and a fatty acid.

Preferably, the triglyceride is a triester of glycerol, and a C4 to C24 fatty acid.

More preferably, the triglyceride is selected from triglycerides having a fatty acid chain length of 10 carbons or more; more preferably, 14 carbons or more; or mixtures thereof.

Preferably, the triglyceride is selected from triglycerides having a fatty acid chain length of 10 to 20 carbons, more preferably 14 to 18 carbons; or mixtures thereof.

In a preferred embodiment, the fat comprises triglycerides having a C14, C16 and C18 fatty acid chain length, and mixtures thereof.

Preferably the fatty acid of the triglyceride is saturated.

In another embodiment, the coating substance comprises, essentially consists or consists of a fat selected from canola oil, cottonseed oil, peanut oil, corn oil, olive oil, soybean oil, sunflower oil, safflower oil, coconut oil, palm oil, linseed oil, tung oil, castor oil and rapeseed oil.

Preferably, the coating substance comprises, essentially consists or consists of a fat selected from hardened canola oil, hardened cottonseed oil, hardened peanut oil, hardened corn oil, hardened olive oil, hardened soybean oil, hardened sunflower oil, hardened safflower oil, hardened coconut oil, hardened palm oil, hardened linseed oil, hardened tung oil, hardened castor oil, and hardened rapeseed oil.

Preferably, the coating substance comprises, essentially consists or consists of a fat selected from fully hardened canola oil, hardened cottonseed oil, fully hardened peanut oil, fully hardened corn oil, fully hardened olive oil, fully hardened soybean oil, fully hardened sunflower oil, fully hardened safflower oil, fully hardened coconut oil, fully hardened palm oil, fully hardened linseed oil, fully hardened tung oil, fully hardened castor oil, and fully hardened rapeseed oil.

In another embodiment, the coating substance consists essentially of a fat selected from palm oil, rapeseed oil, cottonseed oil and soybean oil; preferably, hardened palm oil, hardened rapeseed oil, hardened cottonseed oil and hardened soybean oil; more preferably, fully hardened palm oil, fully hardened rapeseed oil, fully hardened cottonseed oil and fully hardened soybean oil.

In another embodiment, the coating substance comprises a polymer selected for one or more of film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixture thereof.

In another embodiment, the coating substance comprises a polymer selected from water soluble polymers (such as polyvinylalcohol), or a film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixture thereof.

In one embodiment, the coating substance comprises a polymer selected from one or more of ethylcellulose, hydroxyethylcellulose, hydroxypropylcellulose, carrageenan and sodium alginate.

In one embodiment, the coating substance comprises a polymer selected from one or more of ethylcellulose, hydroxyethylcellulose, hydroxypropylcellulose, polyvinylalcohol, carrageenan and sodium alginate.

In another embodiment, the coating substance comprises one or more of the following: ethylcellulose, HMPC, carageenan, sodium alginate, fully hardened palm oil, fully hardened rapeseed oil, fully hardened cottonseed oil and fully hardened soybean oil.

In another embodiment, the coating substance comprises one or more of the following: ethylcellulose, HMPC, polyvinylalcohol, carageenan, sodium alginate, fully hardened palm oil, fully hardened rapeseed oil, fully hardened cottonseed oil and fully hardened soybean oil.

In one embodiment, the polymer is feed grade polymer with a slow rate of aqueous solubility, for example, a polyvinylalcohol. The rate of solubility of polyvinylalcohol can be adjusted by changing the degree of hydrolysis or the molecular weight of the polymer. Increasing either will slow the rate of solubility in water.

Examples of polyvinylalcohols with a high degree of hydrolysis (e.g. fully hydrolysed) are Poval 4-98 (from Kuraray) and SELVOL E103 (from Seiksui). Examples of polyvinylalcohol grades with high molecular weight are Mowial 18-88 (from Kuraray) and SELVOL 107 (from Seiksui).

In one embodiment, the polymer is a fully hydrolysed polyvinylalcohol. In one embodiment, the fully hydrolysed polyvinylalcohol is greater than about 98% hydrolysed. In another embodiment, the fully hydrolysed polyvinylalcohol is about 98% to about 99% hydrolysed.

In one embodiment, the polymer is a high molecular weight polyvinylalcohol. In one embodiment, the number or mass average molecular weight is greater than about 100,000. In another embodiment, the number or mass average molecular weight is greater than about 110,000. In another embodiment, the number or mass average molecular weight is greater than about 120,000. In another embodiment, the number or mass average molecular weight is greater than about 130,000.

In one embodiment, the number or mass average molecular weight is about 100,000 to about 200,000. In one embodiment, the number or mass average molecular weight is about 110,000 to about 190,000. In one embodiment, the number or mass average molecular weight is about 120,000 to about 190,000. In one embodiment, the number or mass average molecular weight is about 130,000 to about 190,000. In one embodiment, the number or mass average molecular weight is about 130,000 to about 170,000. In one embodiment, the number or mass average molecular weight is about 130,000 to about 150,000.

In one embodiment the number or mass average weight is about 131,000.

In one embodiment, the polymer is high molecular weight and fully hydrolysed polyvinylalcohol. More specifically, the polymer is a high molecular weight and fully hydrolysed polyvinylalcohol as defined above,

In another embodiment, the coating substance may further comprise other ingredients, such as inert fillers (e.g. calcium hydrogen phosphate).

In one embodiment, the betaine is coated wherein the betaine is encapsulated within a cross-linked aqueous hydrocolloid droplet which itself is encapsulated in a solid fat droplet.

In another embodiment, the betaine is coated with microlayers of a lipid, preferably the lipid is as described above.

As used herein, “microlayers” refers to layers of coating material under one micron thick. Preferably, a multitude of microlayers are provided.

In one embodiment, the coating itself is composed of multiple microlayers each of which is not continuous around the betaine, but each layer overlaps to completely cover the betaine.

The presence of microlayers can be determined by techniques known to those skilled in the art. For instance scanning electron microscopy (SEM) can be used to visualise the layers. This technique would be familiar to the skilled person and involves freezing a sample in liquid nitrogen and fracturing the particles to reveal the interior structure of the coating. An alternative technique is oil-immersion microscopy.

Microlayers in the coating may be provided by hot melt coating the betaine with a fat. Hot melt coating is a technique familiar to the skilled person further details of which can be found in “Single-Core Encapsulation: Film Coating” Chapter 5, Charles R. Frey and Harlan S. Hall, pages 83-101 in Microencapsulation of Food Ingredients, Ed. Per Vilstrup, 2001 Leatherhead Publishing, LFRA Ltd and “Fluidized bed coating in food technology”, K. Dewettinck* and A. Huyghebaert, Trends in Food Science & Technology 10 (1999) pages 163-168.

In another embodiment, the betaine is coated wherein the betaine is suspended as a dispersed phase within a polymer continuous phase, preferably the polymer is as described above.

In another embodiment, the betaine is coated wherein the betaine and coating substance form a core, and the core is encapsulated with a further coating substance.

The further coating substance may be or may not be the same as the coating substance which coats the betaine.

In one embodiment, the further coating substance is the same as the coating substance which coats the betaine.

In another embodiment, the further coating substance and the coating substance which coats the betaine may be independently selected from the coating substances previously defined herein.

In another embodiment, the betaine is coated wherein the betaine is dispersed within a lipid (e.g. by spray-cooling), preferably the lipid is as described above. The resultant coated betaine forms a core, which is then itself coated (e.g. by hot melt coating) with a layer of lipid to form an encapsulated core. Preferably, the lipid comprises a fat as defined above. More preferably, the lipid is fully hardened palm oil, fully hardened rapeseed oil, fully hardened cottonseed oil or fully hardened soybean oil.

In one embodiment, the betaine is coated with hardened palm oil, preferably microlayers of hardened palm oil.

In another embodiment the betaine is coated with ethylcellulose and plasticizer. Preferably the plasticizer is selected from acetic acid esters of mono- and di-glycerides of fatty acids.

In another embodiment the betaine is coated (entrapped) inside alginate beads which are further incorporated inside solid lipid beads.

In another embodiment the betaine is coated with hydropropylmethylcellulose and carrageenan.

As used herein, the term ‘coated’ may refer to covering the surface of the betaine with a coating substance. Preferably substantially all of the surface area of the betaine is coated. More preferably, all of the surface area of the betaine is coated.

In one embodiment, the term ‘coated’ may refer to covering, encapsulation, suspension or entrapment of the betaine with/within the coating substance.

In one embodiment, the betaine is covered with the coating substance, preferably completely covered.

In another embodiment, the betaine is suspended in the coating substance.

In another embodiment, the betaine is entrapped in the coating substance.

In another embodiment, the betaine is encapsulated in the coating substance.

Uses/Methods

In another aspect, the present invention relates to the use of betaine or a feed acceptable salt or hydrate thereof as a feed meal replacement in an animal feed or an aquafeed.

Particularly preferred feed meals may be selected from fish meal, chicken meal, soybean meal, hydrolysed feather meal, blood meal, meat and bone meal. Preferably, the feed meal is fish meal.

In one embodiment, the betaine may be used as a total replacement or a partial replacement of the feed meal present in the animal feed or aquafeed. Preferably, the betaine is a partial replacement.

As used herein, “total replacement” refers to between 95 to 100% (w/w) of the feed meal has been removed in favour of using an effective amount of betaine, preferably 96 to 100% (w/w), more preferably 97% to 100% (w/w), more preferably 98 to 100% (w/w), more preferably 99 to 100% (w/w), more preferably about 100% (w/w). In one embodiment, substantially all of the feed meal has been removed in favour of an effective amount of betaine.

As used herein, “partial replacement” refers to between 1 to 94% (w/w) of the feed meal has been removed in favour of using an effective amount of betaine, preferably between 10 to 90% (w/w), more preferably between 20 to 90% (w/w), more preferably between 30 to 90% (w/w), more preferably between 40 to 90% (w/w), more preferably between 50 to 90% (w/w), more preferably between 40 to 80% (w/w), more preferably between 40 to 70% (w/w), more preferably between 40 to 60% (w/w), more preferably between 50 to 60% (w/w).

In one embodiment, an effective amount of betaine is about 0.1% (net) (w/w) up to and inclusive of about 1% (net) (w/w), preferably about 0.1% (net) (w/w) up to and inclusive of about 0.7% (net) (w/w), preferably about 0.1% (net) (w/w) up to and inclusive of about 0.5% (net) (w/w), preferably about 0.1% (net) (w/w) up to and inclusive of about 0.4% (net) (w/w), preferably about 0.1% (net) (w/w) up to and inclusive of about 0.3% (net) (w/w), preferably in about 0.25% (w/w).

In another embodiment, an effective amount of betaine is about 0.25% (net) (w/w) up to and inclusive of about 1% (net) (w/w), preferably about 0.25% (net) (w/w) up to and inclusive of about 0.7% (net) (w/w), preferably about 0.25% (net) (w/w) up to and inclusive of about 0.5% (net) (w/w), preferably about 0.25% (net) (w/w) up to and inclusive of about 0.4% (net) (w/w), preferably about 0.25% (net) (w/w) up to and inclusive of about 0.3% (net) (w/w).

In another aspect, the present invention relates to the use of betaine or a feed acceptable salt or hydrate thereof for maintaining or improving the nutritional value of an animal feed or an aquafeed comprising feed meal in a reduced amount.

In another aspect, the present invention relates to the use of betaine or a feed acceptable salt or hydrate thereof for maintaining or improving the utilization of an animal feed or an aquafeed comprising feed meal in a reduced amount.

In another aspect, the present invention relates to the use of betaine or a feed acceptable salt or hydrate thereof for maintaining or improving the nutritional value and utilization of an animal feed or an aquafeed comprising feed meal in a reduced amount.

Maintenance or improvement of nutritional value and/or utilization may be determined as described herein above.

Particularly preferred feed meals may be selected from fish meal, chicken meal, soybean meal, hydrolysed feather meal, blood meal, meat and bone meal. Preferably, the feed meal is fish meal.

In one embodiment, a reduced amount of feed meal is about 10% (w/w) or less of the feed, preferably about 9% (w/w) or less, more preferably about 8% (w/w) or less, more preferably about 7% (w/w) or less, more preferably about 6% (w/w) or less, more preferably about 5% (w/w) or less, more preferably about 4% (w/w) or less, more preferably to between about 0.1 to about 5% (w/w), more preferably to between about 0.5 to about 5% (w/w), more preferably to between about 1 to about 5% (w/w), more preferably to between about 2 to about 5% (w/w), more preferably to between about 1 to about 4% (w/w), more preferably about 4% (w/w).

In one embodiment, a reduced amount of fish meal is about 10% (w/w) or less of the feed, preferably about 9% (w/w) or less, more preferably about 8% (w/w) or less, more preferably about 7% (w/w) or less, more preferably about 6% (w/w) or less, more preferably about 5% (w/w) or less, more preferably about 4% (w/w) or less, more preferably to between about 0.1 to about 5% (w/w), more preferably to between about 0.5 to about 5% (w/w), more preferably to between about 1 to about 5% (w/w), more preferably to between about 2 to about 5% (w/w), more preferably to between about 1 to about 4% (w/w), more preferably about 4% (w/w).

In each of the above aspects, in one embodiment, the feed is selected from a swine feed, a poultry feed, a fish feed or a crustacean feed. Preferably, a fish or crustacean feed. More preferably a shrimp feed.

In each of the above aspects, in one embodiment, the improvement in nutritional value and/or utilization is determined in shrimp.

In another aspect, the present invention relates to a method of providing nourishment to an animal or an aquaspecies comprising feeding to said animal or aquaspecies a feed comprising betaine and fish meal in a reduced amount as defined above.

As used herein, “aquaspecies” refers to fish and crustaceans. Crustaceans are, for example, lobsters, crabs, shrimp, prawns and crayfish. Preferably fish are selected from the salmonid group, for example, cherry salmon (Oncorhynchus masou), Chinook salmon (Oncorhynchus tshawytscha), chum salmon (Oncorhynchus keta), coho salmon (Oncorhynchus kisutch), pink salmon (Oncorhynchus gorbuscha), sockeye salmon (Oncorhynchus nerka) and Atlantic salmon (Salmo salar)+various trout species. Other finfish of interest for aquaculture include, but are not limited to, whitefish such as tilapia (including various species of Oreochromis, Sarotherodon, and Tilapia), grouper (subfamily Epinephelinae), sea bass, catfish (order Siluriformes, genus Pangasus), bigeye tuna (Thunnus obesus), carp (family Cyprinidae) and cod (genus Gadus).

As used herein, the term “animals” refers to any animal commonly the subject of animal husbandry. “Animals” shall include but not be limited to poultry, including chickens, which includes boilers and layers and male and female breeding stock, geese, duck, turkey, pheasant, cornish hens, swine, cattle, which includes beef and dairy production, sheep, equine animals, which includes horses and donkeys, and goats.

Preferably said animals or aquaspecies are selected from poultry, swine, fish and crustaceans. More preferably said animals or aquaspecies are shrimp.

Aquaculture

Aquaculture involves cultivating aquatic populations (e.g., freshwater and saltwater organisms) under controlled conditions. Organisms grown in aquaculture may include fish and crustaceans. Crustaceans are, for example, lobsters, crabs, shrimp, prawns and crayfish. The farming of finfish is the most common form of aquaculture. It involves raising fish commercially in tanks, ponds, or ocean enclosures, usually for food. A facility that releases juvenile fish into the wild for recreational fishing or to supplement a species' natural numbers is generally referred to as a fish hatchery. Particularly of interest are fish of the salmonid group, for example, cherry salmon (Oncorhynchus masou), Chinook salmon (Oncorhynchus tshawytscha), chum salmon (Oncorhynchus keta), coho salmon (Oncorhynchus kisutch), pink salmon (Oncorhynchus gorbuscha), sockeye salmon (Oncorhynchus nerka) and Atlantic salmon (Salmo salar). Other finfish of interest for aquaculture include, but are not limited to, various trout, as well as whitefish such as tilapia (including various species of Oreochromis, Sarotherodon, and Tilapia), grouper (subfamily Epinephelinae), sea bass, catfish (order Siluriformes), bigeye tuna (Thunnus obesus), carp (family Cyprimidae) and cod (genus Gadus).

Aquafeed

As used herein, the term ‘aquafeed’ has the normal meaning attributed to it in the art. For instance, an aquafeed may be considered a manufactured or artificial diet (i.e., formulated feeds) to supplement or to replace natural feeds in the aquaculture industry. These prepared foods are most commonly produced in flake, pellet or tablet form. Typically, an aquafeed refers to artificially compounded feeds that are useful for farmed fish and crustaceans (i.e., both lower-value staple food fish species [e.g., freshwater fish such as carp, tilapia and catfish] and higher-value cash crop species for luxury or niche markets [e.g., mainly marine and diadromous species such as shrimp, salmon, trout, yellowtail, seabass, seabream and grouper]). These formulated feeds are composed of several ingredients in various proportions complementing each other to form a nutritionally complete diet for the aquacultured species.

Aquafeeds are composed of micro and macro components. In general, all components, which are used at levels of more than 1%, are considered as macro components. Feed ingredients used at levels of less than 1% are micro components. Both macro and micro ingredients are subdivided into components with nutritional functions and technical functions. Components with technical functions improve the physical quality of the aquaculture feed composition or its appearance.

Macro components with nutritional functions provide aquatic animals with protein and energy required for growth and performance. With respect to fish, the aquafeed should ideally provide the fish with: 1) fats, which serve as a source of fatty acids for energy (especially for heart and skeletal muscles); and, 2) amino acids, which serve as building blocks of proteins. Fats also assist in vitamin absorption; for example, vitamins A, D, E and K are fat-soluble or can only be digested, absorbed, and transported in conjunction with fats. Carbohydrates, typically of plant origin (e.g., wheat, sunflower meal, corn gluten, soybean meal), are also often included in the feed compositions, although carbohydrates are not a superior energy source for fish over protein or fat.

Fats are typically provided via incorporation of fish meals (which contain a minor amount of fish oil) and fish oils into the aquaculture feed compositions. Extracted oils that may be used in aquafeeds include fish oils (e.g., from the oily fish menhaden, anchovy, herring, capelin and cod liver), and vegetable oil (e.g., from soybeans, rapeseeds, sunflower seeds and flax seeds). Typically, fish oil is the preferred oil, because it contains the long chain omega-3 polyunsaturated fatty acids [“PUFAs”], EPA and DHA; in contrast, vegetable oils do not provide a source of EPA and/or DHA. These PUFAs are needed for growth and health of most aquaculture products. A typical aquafeed will comprise from about 15-30% of oil (e.g., fish, vegetable, etc.), measured as a weight percent of the aquaculture feed composition.

Animal Feed

As used herein the term ‘animal feed’ has the normal meaning attributed to it in the art. For instance, an animal feed may be considered a mixture of components useful in animal nutrition which is fed to animals.

In one embodiment, the animal feed of the present invention is suitable for an animal selected from the following including chickens, which includes boilers and layers and male and female breeding stock, geese, duck, turkey, pheasant, cornish hens, swine, cattle, which includes beef and dairy production, sheep, equine animals, which includes horses and donkeys, goats, and domestic animals, such as cats and dogs.

As well as a protein rich component (e.g. feed meals), animal feeds may include fat, fiber, calcium, and phosphorous. A preferred feed would include corn and/or wheat, soybean meal, fat, animal by-product, and vitamins and minerals.

In one embodiment, the animal feed includes a source of roughage (fibrous material).

Roughage materials may include without limitation one or more of the following: Almond Hulls, Psyllium Seed Husk, Dried Apple Pectin Pulp, Malt Hulls, Dried Apple Pomace, Clipped Oat By-Product, Bagasse, Oat Hulls, Barley Hulls, Oat Mill By-Product, Barley Mill By-Product, Peanut Hulls, Dried, Plain Beet Pulp, Rice Hulls, Buckwheat Hulls, Rice Mill By-Product, Dried Citrus Meal, Rye Mill Run, Dried Citrus Pulp, Soybean Hulls, Citrus Seed Meal, Soybean Mill Feed, Coin Cob Fractions, Soybean Mill Run, Cottonseed Hulls, Sunflower Hulls, Flax Straw By-Product, Ground Straw, Ground Corn Cob, Dried Tomato Pomace.

Roughage may be from grain and usually consists of the outer covering of the grain but may include other parts of the grain generated during the grain milling process. Examples of roughage preferred in the present invention include, rice hulls, soybean hulls, oat hulls, corn cob fractions, ground corn cob, wheat bran, and the like.

In one embodiment, the animal feed may comprise a plant material, such as grasses or legumes. Grasses include among others timothy, ryegrasses, and fescues. Legumes include among others clover, lucerne or alfalfa, peas, beans and vetches. Whole cereals include among others barley, maize (corn), oat, sorghum. Other forage crops include sugarcane, kales, rapes, and cabbages. Also root crops such as turnips, swedes, mangles, fodder beet, and sugar beet (including sugar beet pulp and beet molasses) are used to feed ruminants. Still further crops are tubers such as potatoes, cassava and sweet potato.

In a preferred embodiment the animal feed composition comprises dry grasses, such as hay, and grasses in a preserved state, such as silage. Silage is an ensiled version of the fiber-rich fraction (e.g. from grasses, legumes or whole cereals) whereby material with a high water content is treated with a controlled anaerobic fermentation process (naturally-fermented or additive treated).

In one embodiment, the animal feed may comprise concentrate.

Concentrate is largely made up of cereals (such as barley including brewers grain and distillers grain, maize, wheat, sorghum), but also often contain protein-rich feed ingredients such as soybean, rapeseed, palm kernel, cotton seed and sunflower.

In one embodiment, the animal feed may comprise further components commonly used in animal feeds. For example, sweeteners, such as molasses and honey.

Process for Preparation

In another aspect, the present invention relates to a process for preparation of a feed as defined above.

In one embodiment, the feed is prepared by (i) mixing betaine with other suitable feed ingredients (as described above), (ii) homogenising the mixture and (iii) processing the homogenised mixture into a suitable form.

In one embodiment, in step (iii), the homogenised mixture is pelletized into a form suitable for feeding shrimp e.g. a sinking pellet.

In another embodiment, in step (iii), the homogenised mixture is extruded into flakes and is suitable for feeding fish.

### Examples

### Preparative Example 1

This sample was prepared by spray-drying betaine with hydroxypropylmethyl cellulose (Methocel SGA7C) and an inert filler. Without being bound by theory, HPMC gels in aqueous solution which is believed to reduce diffusion of the betaine through the particle matrix; Methocel SGA7C gels between 30-45° C. The inclusion of an inert filler aims to reduce the payload of the sample and thus reduce the rate of diffusion of betaine.

0.25 kg of HPMC (Methocel SGA150; Dow Chemical Company) was dry-blended with 0.5 kg of betaine (Betafin BT; Finn Feeds) and dispersed in 5 kg cold tap water, using a Silverson homogenizer. 0.4 kg of further Betafin BT and 0.5 kg of Calcium Hydrogen Phosphate, Dihydrate (Chemische Fabrik Budenheim KG) was added to the solution with constant agitation. The suspension was fed to into a Niro 6.3 spray tower under the following conditions:

| Parameter | Setting |
|---|---|
| Atomising Device | Wheel |
| Rotation Speed (rpm) | 8000-10000 |
| Drying inlet air temperature (° C.) | 210-230 |
| Drying outlet air temperature (° C.) | 90-110 |
| Drying air flow (m³hr⁻¹) | 450-550 |

### Preparative Example 2

This sample was prepared by spray-cooling betaine with a suitable lipid followed by a second coating in a fluid bed.

2 kg of betaine (Betafin BT; Finn Feeds) was milled through a Retsch SK100 rotor mill (Plate 15) and added to 3 kg of fully hydrogenated rapeseed oil, held at 90-110° C. and homogenized at high speed with a Silverson mixer. The slurry was atomized into a Niro 6.3 spray tower under the following conditions:

| Parameter | Setting |
|---|---|
| Atomising Device | Wheel |
| Rotation Speed (rpm) | 5500-6500 |
| Cooling air temperature (° C.) | 5-15 |
| Cooling air flow (m³hr⁻¹) | 500-600 |
| Feed temperature (° C.) | 70-80 |

The finished intermediate was sieved through a 1000 μm sieve to remove aggregates.

1.6 kg of the finished intermediate from above (fraction 125-500 μm) was fluidized in a GEA Aeromatic MP1 fluid bed, operating in top-spray mode. The bed was equipped with a Schlick series 970 nozzle connected to a Watson Marlow pump by 3.2 mm electrically traced silicone hose. The coating material, fully hardened rapeseed oil, was held at an elevated temperature in an oil-bath. 0.4 kg of coating material was atomized onto the fluidized intermediate particles under the following conditions:

| Parameter | Setting |
|---|---|
| Bed temperature (° C.) | 53-57 |
| Inlet Air temperature (° C.) | 55-70 |
| Air flow rate (m³hr⁻¹) | 45-70 |
| Melt temperature (° C.) | 120-140 |
| Atomising Air pressure (bar) | 1.4-2.0 |
| Coating rate (kghr⁻¹) | 0.4-0.8 |

The finished product was sieved through 1500 μm sieve to remove aggregates.

### Preparative Example 3

This sample was prepared by hot-melt coating with fully hardened palm oil.

1.85 kg of Betain BT (Finn Feeds) was fluidized in a GEA Aeromatic MP1 fluid bed, operating in top-spray mode. The bed was equipped with a Schlick series 970 nozzle connected to a Watson Marlow pump by 3.2 mm electrically traced silicone hose. The coating material, fully hardened palm oil, was held at an elevated temperature (110° C.) in an oil-bath. 1,235 kg coating material was atomized onto the fluidized Betafin BT particles under the following conditions:

| Parameter | Setting |
|---|---|
| Bed temperature (° C.) | 44-46 |
| Inlet Air temperature (° C.) | 40-50 |
| Air flow rate (m³hr⁻¹) | 80-90 |
| Melt temperature (° C.) | 110 |
| Atomising Air pressure (bar) | 1.6-2.0 |
| Coating rate (kghr⁻¹) | 1.0 |

The finished product was sieved through 1500 μm sieve to remove aggregates.

### Preparative Example 4

This sample was prepared by a combination of hot-melt extrusion and milling. The matrix was a mixture of ethylcellulose and Acetem (as plasticizer). Ethylcellulose is insoluble in water and was used to provide the scaffold of the particles, with the incorporated betaine providing the erodible content.

1 kg of Acetem 70-00 (DuPont) was heated to 60° C. and plated onto 4 kg ethylcellulose (Ethocel Standard 7 Premium; Dow Chemical Company) in a bowl chopper to create a homogenenous coating blend. Betaine (Betafin BT; Finn Feeds) was milled in a Retsch SK Rotor Mill (plate 15). The coating blend and Betafin BT were fed individually into the Clextral BC 45 co-rotating twin-screw extruder, using screw feeders with feed-rates of both streams varying from 4-5 kg/hr. The extruder was equipped with a 0.8 mm die plate. Temperature across the extruder was held constant at 150° C., except for the die plate, which was held at 90° C. Under production, pressure at the die plate varied from 20-40 bar. The extrudate was collected on a conveyor belt, cooled and then milled (Restch SK 100 Rotor Mill, plate 15) to produce the finished product.

### Preparative Example 5

This sample was prepared by spraying an aqueous film coating on betaine in a fluid bed.

A coating solution was prepared contained 300 g of a high molecular weight polyvinylalcohol (Mowial 18-88 from Kuraray), 140 g talc (Imerys Talc) and 25 g of lecithin (Solec CST 35 from DuPont, dissolved in 25 g of ethanol). The coating solution was further diluted with 500 g of cold water, maintained at ambient temperature and stirred constantly during spraying. 1.85 kg of Betain BT (Finn Feeds) was fluidized in a GEA Aeromatic MP1 fluid bed, operating in top-spray mode. The bed was equipped with a Schlick series 970 nozzle connected to a Watson Marlow pump by 3.2 mm silicone hose. 1,397 g of coating solution was atomised onto the Betafin BT under the following conditions:

| Parameter | Setting |
|---|---|
| Bed temperature (° C.) | 46-49 |
| Inlet Air temperature (° C.) | 50-59 |
| Air flow rate (m³hr⁻¹) | 70-100 |
| Coating temperature (° C.) | Ambient |
| Atomising Air pressure (bar) | 2.2 |
| Atomising Air temperature (° C.) | 25 |
| Coating rate (kghr⁻¹) | 0.25-0.45 |

500 g in-process samples were removed at coating amounts equivalent to 5% and 10% coating. The finished product was sieved through 1500 μm sieve to remove aggregates.

### Preparative Example 6A and 6B

These samples were prepared by spray-drying betaine with a fully hydrolysed polyvinylalcohol.

1.41 kg of Betafin BT was dissolved in 0.94 kg of deionized water. 0.25 kg of polyvinylalcohol (6A: Poval 4-98 from Kururay or 6B: Selvol 103 from Seksui) was slowly added to 0.94 kg/1.25 kg of deionized water and heated, under agitation to 95° C. for 15 minutes. The 60% betaine solution was added to the hot polyvinylalcohol solution to give a feed solution with solids content of 43-50% (of which 85% was Betafin BT and 15% was polyvinylalcohol). The feed solution was atomized into a NIRO NP 6.3 spray unit, using a spray wheel (120 mm diameter) with co-current airflow (600 m³hr⁻¹). Wheel speed was 14000-15000 rpm; inlet air temperature 196-203° C., feed rate 52-55 kghr⁻¹ and outlet air temperature 102-111° C. A fine brown powder was collect from the rotary cell with mass yields between 52% (Poval 4-98) and 89% (Selvol E103).

Preparation of an Aquafeed

Betaine (coated or uncoated) was mixed well with the fine powder ingredients, such as flour, and then this mixture was homogeneously mixed with the rest of the ingredients (see Table 2) in a Hobart mixer for at least 30 minutes.

All ingredients were homogenized with water for 15 min before pelleting with a Hobart pelletizer (USA, Model A200T; pellet diameter: 1-3 mm depending on shrimp's size) and they were dried at 60° C. for 24 h. The diets were stored in the refrigerator at 4° C. until used.

The feed was formulated to contain 35% protein, 7% fat and 19 MJ gross energy/kg diet.

Materials

1. Experimental Unit

The feeding experiment (8 weeks) on Pacific white shrimp was conducted at the shrimp farm facilities of Prince of Songkhla University, Pattani Campus in Thailand. The shrimp rearing unit was made up of fiberglass aquarium of 235 L. The parameters to assess the water quality i.e. salinity, dissolved oxygen (DO), temperature and pH were measured daily using standard protocols. There was a weekly monitoring of NH₃ and NO₂. Siphoning of left-over feed and faeces and exchange of 10% of water was done daily.

2. Shrimp

Pacific white leg shrimp (Litopennaeus vannamei) were obtained from a standard farm in Pattani province. Shrimp were acclimatized in a concrete pond for 7 days prior to the start of the experiment. It was ensured that the juveniles were not infested with bacteria, parasites and viruses. At the start of the feeding trial, the shrimp had an average body weight of 1.4 g. They were sorted and allotted randomly for a particular feed group. 30 shrimps were introduced into each of the 235 L fibreglass aquarium (5 aquariums per feed group). It was confirmed that there was no significant difference in the initial weights of the groups. They were grown in the system for 8 weeks.

3. Experimental Feeds

Experimental shrimp feeds were used. Details of treatment groups (n=5) in this study are presented in table 1.

Since betaine function involves the protein pathway due to its induction of methionine and choline metabolism and because it could be considered as energy source, its incorporation in feed was in replacement of certain proportion of fish meal, also considered as main energy source in aquafeed.

In the present study, positive control was based on 9% fish meal whereas negative control with or without betaine products) was based on 4% fish meal as indicated in the feed formulation in table 2.

The test article is Betaine (Betafin® BT natural betaine, Dupont-Danisco) with or without coating.

The coating technology used in the present study was that used in preparative example 3.

The coated betaine was prepared by hot-melt coating in a fluid bed. The betaine was fluidised by a stream of hot-air and molten fat is sprayed onto the particles, to form a uniform coating layer. In the version we have prepared for the trials, we have added 40% fully hardened palm oil (melting point 60° C.), but other triglycerides can be used (e.g. hardened soya, rapeseed, cottonseed, etc) and the coating amount can be varied. The coating layer is composed of many micro-layers of fat and it is this layered structure which makes the coating impermissible for water flow.

TABLE 1
Description of treatments:

| | | Number | | |
|---|---|---|---|---|
| | | of | | Equivalent |
| N^{o} | treatment | replicates | Dose tested | Betaine |
| 1 | Positive Control group (PC-FM | 5 | | |
| | 9%) | | | |
| 2 | Negative Control group (NC- | 5 | — | — |
| | FM 4%) | | | |
| 3 | NC + Uncoated Betafin 0.5% | 5 | 5 kg/tonne of | 5 kg/tonne of feed |
| | | | feed | |
| 4 | NC + Uncoated Betafin 1% | 5 | 10 kg/tonne of | 10 kg/tonne of |
| | | | feed | feed |
| 5 | NC + Coated Betafin | 5 | 4.2 kg/tonne of | 2.5 kg/tonne of |
| | (Preparative example 3) | | feed | feed |

TABLE 2
Detail of feed formulations:

| | Positive Control | Negative |
|---|---|---|
| | group (PC- | Control group |
| Ingredients | FM 9%) | (NC-FM 4%) |
| Fish meal | 9.00 | 4.00 |
| Squid liver meal | 3.00 | 0.00 |
| Corn gluten | 0.00 | 3.00 |
| Soybean de-hulled | 30.00 | 40.00 |
| Canola Meal | 10.00 | 10.00 |
| Wheat flour | 27.30 | 21.60 |
| Rice bran (dehulled) | 10.00 | 10.00 |
| Wheat gluten (pellet | 3.00 | 3.00 |
| binder) | | |
| Fish oil | 2.00 | 2.00 |
| Soybean oil | 0.10 | 0.20 |
| Lecithin | 1.00 | 1.00 |
| vitamin and mineral premix | 2.00 | 2.00 |
| DCP | 2.50 | 3.10 |
| Choline chloride | 0.10 | 0.10 |
| Betaine (Betafin ® BT) | 0.00 | [Different forms and |
| | | levels] |
| Total | 100.00 | 100.00 |

4. Feeding Regime

The experimental feeds were hand fed everyday; four times a day. Feed consumption as well as amount of unconsumed feed were monitored (weighed) daily.

Daily feed was based on feed guide x number of surviving animals, and was predetermined one week in advance, but was adjusted on a daily basis if significant amount of feed remained non eaten or if all feed was consumed, in order to avoid underfeeding or overfeeding. The animals were weighed every 2 weeks—all animals in each of the aquaria were weighed.

5. Methods and Data Analyses (Growth Performance and Feed Utilisation)

The bulk weights of shrimp were recorded from each experimental unit at the start of the feeding period. Weight measurement was examined every two weeks by sampling 10% of white shrimp in each net cage (at week 2, 4, 6, and 8). At the end of the study (8 weeks), all shrimp in each net cage were weighed. The number of survivors was also checked. The determination of weight gain was based on the total biomass in each net cage considering the number of survivors.

The following formulae were used to calculate the growth performance parameters:

Survival (%)=100 (Final shrimp number/Initial shrimp number)

Weight gain, WG (%)=[[(Mean final bodyweight)−(Mean initial body weight)]/Mean initial body weight]×100.

Average daily gain, ADG (g/shrimp/day)=body weight gain (g)/time (days)

Specific growth rate, SGR (%/day)=100[Ln(Mean final body weight)−Ln(Mean initial body weight)]/time (days).

Using the growth data and the feed consumption, the experimental feeds were evaluated as follows:

Rate of feed intake (%/BW/day)=Feed intake (g)×100/[((mean final BW+mean initial BW)/2)×((number of final shrimp+number of initial shrimp)/2)×time (days)].

Feed conversion ratio, FCR=Dry feed intake (g)/[Final biomass (g)−Initial biomass (g)+Biomass of the dead shrimp (g)].

Results

The feeding trial was completed successfully and health analyses were performed on the shrimp samples that were collected. There were no noticeable differences in the appearance of the shrimp from the different groups. The growth and feed conversion data is presented for the entire 8 weeks duration. The growth performance parameters of the shrimp and feed utilization are summarized in Tables 3 and 4, respectively.

From this in vivo study with various Betaine samples with and without above mentioned coating, it appeared that positive control with 9% fish meal (PC) induced significant higher growth performance and feed utilisation efficiency than negative control with 4% fish meal (NC) meaning that both controls were validated.

In terms of growth performance (final bodyweight), NC (4% FM) supplemented with coated betaine product at 0.25% of betaine gave statistically similar results to PC (9% FM) or NC+uncoated betaine at 1.0% (table 3). Moreover, NC (4% FM) supplemented with coated betaine product at 0.25% of betaine gave the highest homogeneity in terms of response (indicated by the lowest CVs values).

Survival did not statistically differ among the different groups (table 3).

TABLE 3
Growth performance parameters

| | | | NC + | | NC + |
|---|---|---|---|---|---|
| | Positive | Negative | Uncoated | NC + | Coated |
| | control | control | Betafin | Uncoated | Betafin |
| | (9% FM) | (4% FM) | 0.5% | Betafin 1% | 0.25% |
| Final individual | 5.64 ± 0.70ab | 4.56 ± 0.26c | 5.58 ± 0.29ab | 6.06 ± 0.82a | 5.55 ± 0.28ab |
| body weight | CV: 12.4% | CV: 5.7% | CV: 5.1% | CV: 13.5% | CV: 5.0% |
| gain (g/shrimp) | | | | | |
| Survival (%) | 99.2 ± 1.7a | 98.3 ± 1.9ab | 95.8 ± 4.2abcd | 95.0 ± 3.3abcd | 97.5 ± 3.2abc |
| | CV: 1.7% | CV: 1.9% | CV: 4.4% | CV: 3.5% | CV: 3.2% |

a > b > c > d ANOVA p < 0.05

In terms of feed utilization parameters (FCR and feed intake), NC (4% FM) supplemented with coated betaine product at 0.25% betaine gave similar or better results than PC (9% FM) or NC+uncoated betaine at 1.0% (table 4). Moreover, NC (4% FM) supplemented with coated betaine product at 0.25% betaine gave the response with the highest homogeneity in terms of response (indicated by the lowest CVs values).

The above results also confirm the potential of palatability of betaine because the highest feed intake was observed with betaine supplemented at 1%. This value was significantly higher than positive control.

TABLE 4
Feed utilization parameters

| | | | NC + | | NC + |
|---|---|---|---|---|---|
| | Positive | Negative | Uncoated | NC + | Coated |
| | control | control | Betafin | Uncoated | Betafin |
| | (9% FM) | (4% FM) | 0.5% | Betafin 1% | 0.25% |
| FCR | 1.90 ± 0.27a | 2.01 ± 0.09ab | 1.83 ± 0.09a | 1.85 ± 0.21a | 1.81 ± 0.04ab |
| | CV: 14.2% | CV: 4.5% | CV: 4.9% | CV: 11.3% | CV: 2.2% |
| Feed intake | 7.91 ± 0.59ab | 6.32 ± 0.35d | 7.60 ± 0.51b | 8.46 ± 0.48a | 7.48 ± 0.42b |
| | CV: 7.5% | CV: 5.5% | CV: 6.7% | CV: 5.6% | CV: 5.6% |

a > b > c > d ANOVA p < 0.05

### CONCLUSION

There were no noticeable differences in the appearance and health of juvenile shrimp from the different groups. The shrimp in all treatments grew well for the entire experimental period. However, both coated and uncoated betaine products induced clear growth performance and feed utilization improvement compared with controls, indicating that betaine could substitute 5% fish meal in the feed formulation.

The additive value of coated technology compared with uncoated product is linked to the fact that the amount of feed additive needed could be reduced. Furthermore, the coating technology may reduce the variability of performance in shrimp populations since the leaching in water is lower and thus more betaine reaches the shrimp gut.

All references, including publications, patent applications, and patents, cited herein are hereby incorporated by reference in their entirety and to the same extent as if each reference were individually and specifically indicated to be incorporated by reference and were set forth in its entirety herein (to the maximum extent permitted by law).

All headings and sub-headings are used herein for convenience only and should not be construed as limiting the invention in any way.

The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The citation and incorporation of patent documents herein is done for convenience only and does not reflect any view of the validity, patentability, and/or enforceability of such patent documents.

This invention includes all modifications and equivalents of the subject matter recited in the claims appended hereto as permitted by applicable law.

1. A feed for use as an animal feed or aquafeed; wherein said feed comprises feed meal and betaine or a feed acceptable salt or hydrate thereof; wherein said feed provides at least a similar nutritional value, when fed to an animal or an aquaspecies, as compared with the nutritional value provided by a comparable feed that contains a higher level of feed meal and does not contain betaine or a feed acceptable salt or hydrate thereof.

2. A feed for use as an animal feed or aquafeed; wherein said feed comprises feed meal and betaine or a feed acceptable salt or hydrate thereof; wherein said feed provides at least a similar utilization, when fed to an animal or an aquaspecies, as compared with the utilization provided by a comparable feed that contains a higher level of feed meal and does not contain betaine or a feed acceptable salt or hydrate thereof.

3. The feed of claim 1 or claim 2 wherein the comparable feed comprises between 50% and 400% more feed meal than the feed which comprises betaine.

4. A feed for use as an animal feed or aquafeed, wherein said feed comprises betaine or a feed acceptable salt or hydrate thereof and a feed meal in a reduced amount.

5. The feed of claim 1 or 2 wherein the feed meal is fish meal.

6. The feed of claim 1 or 2 comprising less than 9% (w/w) of fish meal, preferably 4% (w/w) or less, more preferably between 1% and 4% (w/w).

7. The feed of claim 1 or 2 comprising about 0.1% (w/w) betaine or more, preferably 0.25% (w/w) or more, more preferably between 0.25% and 1% (w/w).

8. The feed of claim 1 or 2 wherein the betaine is coated with a coating substance.

9. The feed of claim 8 wherein the coating substance comprises a lipid, an emulsifier or a polymer.

10. The feed of claim 9 wherein the coating substance comprises an emulsifier selected from fatty acid monoglycerides, diglycerides, polyglycerol esters and sorbitan esters of fatty acids.

11. The feed of claim 9 wherein the coating substance comprises a polymer selected from film-forming polysaccharide or protein selected from one or more of the group of cellulosic polymers (methyl cellulose, carboxymethyl cellulose, hydroxypropylmethyl cellulose, ethylcellulose, hydroxyethylcellulose, hydroxypropylcellulose), sodium alginate, gum arabic, gellan gum, starch, modified starch, guar gum, agar gum, pectin, amidified pectin, carrageenan, gelatine, chitosan, mesquite gum, hyaluronic acid, whey protein, soy protein, sodium caseinate, xanthan/locust bean gum mixture, any food/feed grade protein and mixtures thereof.

12. The feed of claim 9 wherein the coating substance comprises a lipid selected from animal oils or fats, vegetable oils or fats, triglycerides, free fatty acids, animal waxes, (such as beeswax, lanolin, shell wax or Chinese insect wax), vegetable waxes (such as carnauba, candelilla, bayberry or sugarcane), mineral waxes, synthetic waxes, natural and synthetic resins and mixtures thereof.

13. The feed of claim 12 wherein the coating substance comprises a lipid selected from hardened vegetable oils or fats, triglycerides, and mixtures thereof.

14. The feed of claim 12 wherein the coating substance comprises a fat.

15. The feed of claim 14 wherein the coating substance comprises a fat which has a melting point of about 40° C. to about 80° C.

16. The feed of claim 14 wherein the coating substance comprises a fat which is a fully hardened fat.

17. The feed of claim 14 wherein the coating substance comprises a fat which is comprised of triglycerides.

18. The feed of claim 17 wherein the coating substance comprises a fat which is comprised of triglycerides having a C14, C16 and C18 fatty acid chain length, and mixtures thereof.

19. The feed of claim 14 wherein the coating substance comprises a fat selected from canola oil, cottonseed oil, peanut oil, corn oil, olive oil, soybean oil, sunflower oil, safflower oil, coconut oil, palm oil, linseed oil, tung oil, castor oil and rapeseed oil.

20. The feed of claim 14 wherein the coating substance is selected from ethylcellulose, HMPC, alginate, fully hardened palm oil, fully hardened rapeseed oil, fully hardened cottonseed oil and fully hardened soybean oil.

21. The feed of claim 8 wherein the coating substance comprises a polyvinylalcohol.

22. The feed of claim 8 wherein the coating substance comprises microlayers.

23. The feed of claim 8 wherein the betaine and coating substance form a core of the composition, and wherein the core is coated with a further coating substance.

24. The feed of claim 1 or 2 wherein the feed is an aquafeed provided as pellets.

25. The feed of claim 24 wherein the feed is an aquafeed provided as flakes.

26. The feed of claim 1 or 2 having an FCR of between about 1 and about 3 in shrimp.

27-31. (canceled)
